(19) United States
(12) Patent Application Publication
(10) Pub. No.: US 2013/0052889 A1
(43) Pub. Date: Feb. 28, 2013

(54) Structure of Flag Terminal

(71) Applicant: Chu-Ping Shen, New Taipei City (TW)

(72) Inventor: Chu-Ping Shen, New Taipei City (TW)

(21) Appl. No.: 13/221,316

(22) Filed: Aug. 30, 2011

(51) Int. Cl. H01R 13/02

(52) U.S. Cl. 439/890

(57) ABSTRACT

An improved structure of flag terminal, which allows to increase the local cross section of the flag terminal and improve its conductivity by converting the excess stock after punching process; the flag terminal comprising: a substrate with a draw hole; an extended plugging portion, which is extended outwards from the substrate and. rolled into a cylindrical shape from its both sides; an extended contact arm, which is extended from one side of the substrate adjacent to the plugging portion, and. provided with several riveting sheets (or riveting feet) protruded from the surface of the substrate; in particular, a first feeding portion of certain protruding area is shaped on the edge opposite to the draw hole of the substrate, and a second feeding portion of larger protruding area is shaped on the periphery between the substrate and plugging portion; and also a third feeding portion of certain protruding area. is formed among several riveting sheets or riveting feet on the contact arm.

### BACKGROUND OF INVENTION

1. Field of the Invention

The present invention relates generally to a flag terminal structure, and more particularly to an improved one which is applied to vehicle fuses.

2. Description of Related Art

A flag terminal already applied to fuses is illustrated in FIG. 1, wherein the flag terminal is set on circuit substrate for inserting fuse to realize the intended electrical connection.

As shown in the figure, the flag terminal is punched by metal plates, and comprised of: a substrate 1 with a draw hole 11; an extended plugging portion 2, which is extended outwards from the substrate 1 and rolled into a cylindrical shape from its both sides; an extended contact arm 3, which is extended from one side of the substrate 1 adjacent to the plugging portion 2, and provided with several riveting sheets 31 or riveting feet protruded from the surface of the substrate 1, thus enabling electrical connection between the flag terminal and circuit substrate.

The flag terminals are commonly used in a broad range of industrial applications. Recently, stainless steel or iron materials are adopted in lieu of copper materials to improve the conductivity for environmental friendliness, and also subject to surface electroplating to enhance the operating performance and market competitive power for meeting the customer demands. Yet, this will lead to increasing cost and poorer economic efficiency as an extra burden.

In particular, wastes will be generated from the punching and fabrication process of flag terminals while aesthetically-pleasing lugging portion and contact portion are shaped; but the substrate for mating with these portions will become thinner against current flow; in fact, these materials have no effect on the functional characteristics of various portions, but waste of resources and higher cost will be caused from mass production of flag terminals, so efficient utilization of the materials could improve the properties and performance of existing flag terminals.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The primary objective of the present invention is to provide an improved structure of flag terminal, which allows to increase the total cross section of the flag terminal by converting the excess stock after punching process, permitting larger operating current to flow through it so as to reduce the current-induced damage of terminals.

The improved flag terminal of the present invention comprising: a substrate, with a draw hole; an extended plugging portion, which is extended outwards from the substrate and rolled into a cylindrical shape from its both sides; an extended contact arm, which is extended from one side of the substrate adjacent to the plugging portion, and provided with several riveting sheets (or riveting feet) protruded from the surface of the substrate; the major improvement lies in that, a first feeding portion of certain protruding area is shaped on the edge opposite to the draw hole of the substrate, and a second feeding portion of larger protruding area is shaped on the periphery between the substrate and plugging portion; with this design, the excess stock in the manufacturing process could he fully utilized to convert into available cross section, such that the cross section for the flow of operating current between the plugging portion and substrate could be increased, permitting larger operating current to flow through it so as to improve the conductivity of terminals and reduce the current-induced damage.

Said flag terminal also comprises a third feeding portion of certain protruding area formed among several riveting sheets or riveting feet on the contact arm.

The features and technical contents of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1: an outside view of conventional flag terminal.

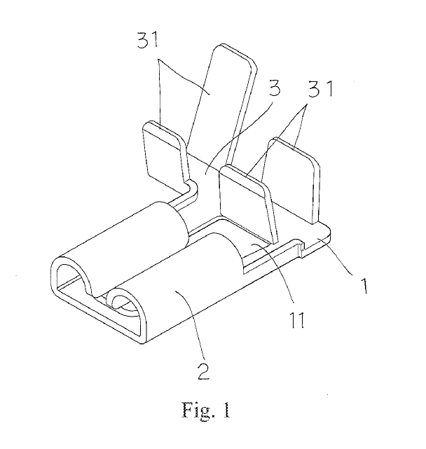

FIG. 2: a structural view of a preferred embodiment of the flag terminal of the present invention.

FIG. 3: a sectional view (1) of a preferred embodiment of the flag terminal of the present invention.

FIG. 4: a sectional view (2) of a preferred embodiment of the flag terminal of the present invention.

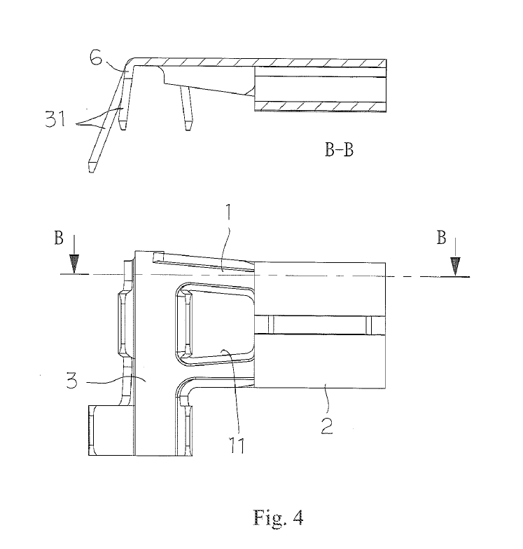

### DETAILED DESCRIPTION OF THE INVENTION

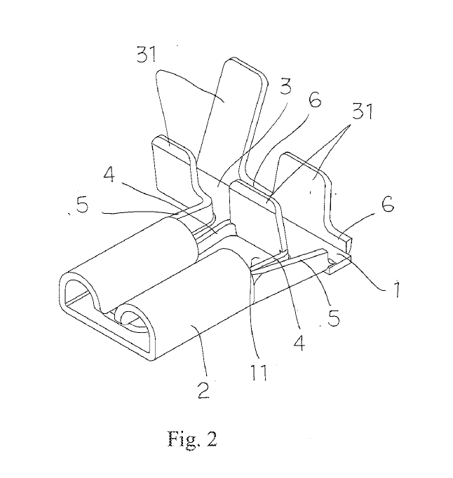

Referring to FIG. 2, the flag terminal is made of highly conductive metal. material, comprising: a substrate 1 with a draw hole 11; an extended plugging portion 2, which is extended outwards from the substrate 1 and rolled into a cylindrical shape from its both sides; an extended contact arm 3, which is extended from one side of the substrate adjacent to the plugging portion, and provided with several riveting sheets 31 (or riveting feet) protruded from the surface of the substrate 1, thus enabling electrical connection between the flag terminal and circuit substrate.

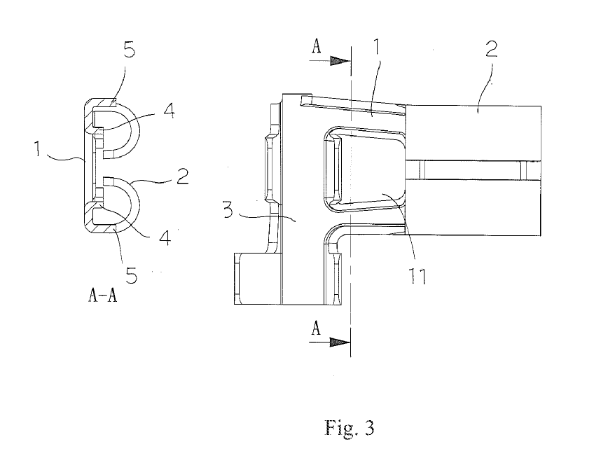

Referring also to FIG. 3, the present invention is mainly characterized by that:

a first feeding portion 4 of certain protruding area is shaped on the edge opposite to the draw hole 11 of the substrate 1, and a second feeding portion 5 of larger protruding area is shaped on the periphery between the substrate 1 and plugging portion 2; the shapes of the first feeding portion 4 and second feeding portion 5 are not limited.

With this design, the excess stock in the manufacturing process could be fully utilized to convert into available cross section, such that the cross section for the flow of operating current between the plugging portion 2 and substrate 1 could be increased, permitting larger operating current to flow through it so as to improve the conductivity of terminals and reduce the current-induced damage. Said flag terminal of the present invention comprises a third feeding portion 6 of certain protruding area formed among several riveting sheets 31 or riveting feet on the contact arm 3.

With the aforementioned technical means, the present invention could efficiently avoid waste of materials in manufacturing of flag terminals and convert into available resources to increase the cross section of the substrate, without need of highly conductive and expensive materials for better economic benefits; on the other hand, this could address the shortcomings of extremely thin substrate against current flow, thus improving significantly the conductivity of flag terminals.

Although the invention has been explained in relation to its preferred embodiment, it is to be understood that many other possible modifications and variations can be made without departing from the spirit and scope of the invention as hereinafter claimed.

1. An improved structure of flag terminal, comprising: a substrate with a draw hole; an extended plugging portion, which is extended outwards from the substrate and rolled into a cylindrical shape from its both sides; an extended contact arm, which is extended from one side of the substrate adjacent to the plugging portion, and provided with several riveting sheets (or riveting feet) protruded from the surface of the substrate; it is characterized by that:
a first feeding portion of certain protruding area is shaped on the edge opposite to the draw hole of the substrate, and a second feeding portion of larger protruding area is shaped on the periphery between the substrate and plugging portion.

2. The improved structure of flag terminal as claimed in claim 1, wherein a third feeding portion of certain protruding area is formed among several riveting sheets or riveting feet on the contact arm.
